(19) United States
(12) Patent Application Publication
(10) Pub. No.: US 2021/0166606 A1
(43) Pub. Date: Jun. 3, 2021

(54) Method for Obtaining Luminance Correction Relationships of Three Primary Colors, Correction Method and Correction Apparatus of Display

(71) Applicant: BOE TECHNOLOGY GROUP CO., LTD., Beijing (CN)

(72) Inventors: Dongxu HAN, Beijing (CN); Tieshi WANG, Beijing (CN); Zhongyuan WU, Beijing (CN); Wei CHEN, Beijing (CN); Enming XIE, Beijing (CN); Chi ZHANG, Beijing (CN); Yongqian LI, Beijing (CN)

(21) Appl. No.: 17/264,126

(22) PCT Filed: May 27, 2020
(86) PCT No.: PCT/CN2020/092612

§ 371 Date: Jan. 28, 2021

(30) Foreign Application Priority Data
May 30, 2019 (CN) 201910465668.6

(51) Int. Cl. G09G 3/20; G09G 3/3208

(52) U.S. Cl. CPC G09G 3/2003; G09G 3/3208; G09G 2320/0242; G09G 2320/0673; G09G 2320/0233; G09G 2320/0276

(57) ABSTRACT

A method includes: setting target white color coordinates, a target white luminance and a gamma value; calculating a first luminance value of each primary color at each gray scale; measuring color coordinates of the primary color at each gray scale, and generating a list of a correspondence among the gray scale, the first luminance value and the color coordinates of the primary color; selecting a plurality of gray scales, and obtaining color coordinates corresponding to one of the plurality of gray scales; calculating a second luminance value of the primary color at each of the plurality of gray scales; and obtaining and storing a luminance correction relationship of the primary color according to the second luminance value of the primary color at each of the plurality of gray scales and the first luminance values corresponding to each of the plurality of gray scales.

### CROSS-REFERENCE TO RELATED APPLICATIONS

This application is a national phase entry under 35 USC 371 of International Patent Application No. PCT/CN2020/092612 filed on May 27, 2020, which claims priority to Chinese Patent Application No. 201910465668.6, filed on May 30, 2019, which are incorporated herein by reference in their entirety.

### TECHNICAL FIELD

The present disclosure relates to the field of display technologies, and in particular, to a method for obtaining luminance correction relationships of three primary colors, a correction method and a correction apparatus of a display.

### BACKGROUND

An organic light emitting diode (OLED) display is a mainstream applied in a display panel in the market at present. Compared with a liquid crystal display (LCD), the OLED display has advantages such as low energy consumption, low manufacturing cost, self-luminescence, a wide viewing angle and a fast response speed.

A gray scale curve is a characteristic curve that shows a relationship between a gray scale and a change of a luminance of a display. In order to make the luminance of the display consistent with human vision, a gamma correction is introduced in manufacturing of the OLED display, so that a display effect of the OLED display can be optimal.

### SUMMARY

In an aspect, a method for obtaining luminance correction relationships of three primary colors is provided. The method includes: setting target white color coordinates, a target white luminance and a gamma value; calculating a first luminance value of each primary color at each gray scale according to the target white color coordinates, the target white luminance and the gamma value; measuring color coordinates of the primary color at each gray scale, and generating a list of a correspondence among the gray scale, the first luminance value and the color coordinates of the primary color; selecting a plurality of gray scales, and obtaining color coordinates corresponding to each of the plurality of gray scales according to the list; calculating a second luminance value of the primary color at each of the plurality of gray scales according to the target white color coordinates, the color coordinates and the target white luminance; and obtaining and storing a luminance correction relationship of the primary color according to the second luminance value of the primary color at each of the plurality of gray scales and the first luminance value corresponding to each of the plurality of gray scales.

In some embodiments, calculating the first luminance value of the primary color at each gray scale according to the target white color coordinates, the target white luminance and the gamma value includes: obtaining stable color coordinates of the primary color when a display displays a picture of the primary color; calculating an initial luminance of the primary color according to the stable color coordinates of the primary color, the target white color coordinates and the target white luminance; and calculating the first luminance value of the primary color at each gray scale according to the initial luminance of the primary color and the gamma value.

In some embodiments, calculating the initial luminance of the primary color according to the stable color coordinates of the primary color, the target white color coordinates and the target white luminance includes: calculating an initial luminance ratio of the primary color according to the stable color coordinates of the primary color and the target white color coordinates; and calculating the initial luminance of the primary color according to the initial luminance ratio of the primary color and the target white luminance.

In some embodiments, calculating the first luminance value of the primary color at each gray scale according to the initial luminance of the primary color and the gamma value includes: obtaining a number of gray scales of the display; using the initial luminance of the primary color as a luminance value of the primary color at a maximum gray scale; and calculating a luminance value of the primary color at each gray scale, according to a relational expression

$${L}_{X} = {( \frac{X}{MAX} )}^{GAM} \times L$$

among the gray scale, the corresponding luminance value and the gamma value, as the first luminance value. GAM is the gamma value, MAX is the maximum gray scale, X is an X-th gray scale, L is the luminance value at the maximum gray scale, and L_{X} is a luminance value corresponding to the X-th gray scale, and X is an integer.

In some embodiments, calculating the second luminance value of the primary color at each of the plurality of gray scales according to the target white color coordinates, the color coordinates and the target white luminance includes: calculating a first intermediate luminance ratio of the primary color at each of the plurality of gray scales according to the target white color coordinates and the color coordinates; and calculating the second luminance value of the primary color at each of the plurality of gray scales according to the first intermediate luminance ratio and the target white luminance.

In some embodiments, calculating the second luminance value of the primary color at each of the plurality of gray scales according to the target white color coordinates, the color coordinates and the target white luminance includes: calculating a first intermediate luminance ratio of the primary color at each of the plurality of gray scales according to the target white color coordinates and the color coordinates; calculating a first intermediate luminance value of the primary color at each of the plurality of gray scales according to the first intermediate luminance ratio and the target white luminance.

Following steps are cycled at least once: obtaining the color coordinates of the primary color at each of the plurality of gray scales from the list according to the first intermediate luminance value of the primary color at each of the plurality of gray scales, to calculate a second intermediate luminance ratio of the primary color at each of the plurality of gray scales according to the target white color coordinates and the color coordinates; calculating a second intermediate luminance value of the primary color at each of the plurality of gray scales according to the second intermediate luminance ratio of the primary color at each of the plurality of gray scales and the target white luminance; using a second intermediate luminance value obtained in each cycle as a first intermediate luminance value of a next cycle except for a last cycle; and using a second intermediate luminance value obtained after completion of the last cycle as the second luminance value.

In some embodiments, obtaining and storing the luminance correction relationship of the primary color according to the second luminance value of the primary color at each of the plurality of gray scales and the first luminance value corresponding to each of the plurality of gray scales includes: obtaining a ratio of the second luminance value of the primary color at each of the plurality of gray scales to the first luminance value corresponding to each of the plurality of gray scales according to the second luminance value of the primary color at each of the plurality of gray scales and the first luminance value corresponding to each of the plurality of gray scales; and obtaining and storing the luminance correction relationship of the primary color according to the ratio.

In some embodiments, obtaining and storing the luminance correction relationship of the primary color according to the ratio includes: performing a linear difference processing or fitting processing on the ratio to obtain and store the luminance correction relationship of the primary color.

In some embodiments, the three primary colors are red, green and blue colors.

In another aspect, a correction method of a display is provided. The correction method includes: measuring a luminance of each of three primary colors of the display at each gray scale; calculating a target luminance of the primary color at each gray scale according to the luminance correction relationship of the primary color obtained by the method in any one of the above embodiments, and the luminance of the primary color measured at each gray scale; obtaining a target driving voltage corresponding to the target luminance of the primary color at each gray scale; and adjusting a driving voltage of the display at each gray scale to the target driving voltage, so that the luminance of the primary color at each gray scale is the target luminance.

In yet another aspect, a correction apparatus of a display is provided. The correction apparatus includes a measuring device, a calculating device, an obtaining device and an adjusting device. The calculating device is coupled with the measuring device, the obtaining device is coupled with the calculating device, and the adjusting device is coupled with the obtaining device. The measuring device is configured to measure a luminance of each of three primary colors of the display at each gray scale. The calculating device is configured to calculate a target luminance of the primary color at each gray scale according to the luminance correction relationship of the primary color obtained by the method for obtaining the luminance correction relationship in any one of the above embodiments, and the luminance of the primary color measured at each gray scale. The obtaining device is configured to obtain a target driving voltage corresponding to a target luminance of the primary color at each gray scale. The adjusting device is configured to adjust a driving voltage of the display at each gray scale to the target driving voltage, so that the luminance of the primary color at each gray scale is the target luminance.

In yet another aspect, a display device is provided. The display device includes: the correction apparatus of the display as described above and a display. The display is coupled with the correction apparatus.

In yet another aspect, a computer-readable storage medium is provided. The computer-readable storage medium stores computer program instructions which when executed on a processor, cause one or more steps of the method for obtaining the luminance correction relationship in any one of the above embodiments to be performed; or one or more steps of the correction method as described above to be performed.

In yet another aspect, an electronic apparatus is provided. The electronic apparatus includes a storage device and a processing device. The storage device stores one or more computer programs that are executed on the processing device. When the computer programs are executed on the processing device, the processing device performs one or more steps of the method for obtaining the luminance correction relationship in any one of the above embodiments; or performs one or more steps of the correction method as described above.

In yet another aspect, a computer program product is provided. The computer program product includes computer program instructions that, when executed on a computer, cause the computer to perform one or more steps of the method for obtaining the luminance correction relationship in the above embodiments, or to perform one or more steps of the correction method as described above.

In yet another aspect, a computer program is provided, When the computer program is executed on the computer, the computer program causes the computer to perform one or more steps of the method for obtaining the luminance correction relationship in any one of the above embodiments, or to perform one or more steps of the correction method as described above.

### BRIEF DESCRIPTION OF THE DRAWINGS

In order to describe technical solutions in the present disclosure more clearly, accompanying drawings to be used in some embodiments of the present disclosure will be introduced below briefly. Obviously, the accompanying drawings to be described below are merely accompanying drawings of some embodiments of the present disclosure, and a person of ordinary skill in the art can obtain other drawings according to these drawings. In addition, the accompanying drawings to be described below may be regarded as schematic diagrams, and are not limitations on an actual size of a product, an actual process of a method and an actual timing of a signal to which the embodiments of the present disclosure relate.

FIG. 1 is a flow diagram of a method for obtaining a luminance correction relationship, in accordance with some embodiments;

FIG. 2 is another flow diagram of a method for obtaining a luminance correction relationship, in accordance with some embodiments;

FIG. 3 is yet another flow diagram of a method for obtaining a luminance correction relationship, in accordance with some embodiments;

FIG. 4 is yet another flow diagram of a method for obtaining a luminance correction relationship, in accordance with some embodiments;

FIG. 5 is yet another flow diagram of a method for obtaining a luminance correction relationship, in accordance with some embodiments;

FIG. 6 is yet another flow diagram of a method for obtaining a luminance correction relationship, in accordance with some embodiments;

FIG. 7 is yet another flow diagram of a method for obtaining a luminance correction relationship, in accordance with some embodiments;

FIG. 8 is yet another flow diagram of a method for obtaining a luminance correction relationship, in accordance with some embodiments;

FIG. 9 is a flow diagram of a correction method, in accordance with some embodiments;

FIG. 10 is a diagram showing a structure of a correction apparatus, in accordance with some embodiments;

FIG. 11 is a diagram showing a structure of a display device, in accordance with some embodiments; and

FIG. 12 is a diagram showing a structure of an electronic apparatus, in accordance with some embodiments.

### DETAILED DESCRIPTION

Technical solutions in some Technical solutions in some embodiments of the present disclosure will be described below clearly and completely in combination with accompanying drawings. Obviously, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, the term “comprise” and other forms thereof such as the third-person singular form “comprises” and the present participle form “comprising” throughout the description and the claims are construed in an open and inclusive sense, i.e., “include, but not limited to”. In the description, terms such as “one embodiment”, “some embodiments”, “exemplary embodiments”, “example”, “specific example”, or “some examples” are intended to indicate that specific features, structures, materials or characteristics related to the embodiment(s) or example(s) are included in at least one embodiment or example of the present disclosure. Schematic expressions of the above terms do not necessarily refer to the same embodiment(s) or example(s). In addition, specific features, structures, materials or characteristics may be included in any one or more embodiments or examples in any suitable manner.

Hereinafter, terms such as “first” and “second” are used for descriptive purposes only, and are not to be construed as indicating or implying the relative importance or implicitly indicating the number of indicated technical features below. Thus, features defined with “first” and “second” may explicitly or implicitly include one or more of the features. In the description of the embodiments of the present disclosure, the term “a plurality of” means two or more unless otherwise specified.

In the description of some embodiments, the terms such as “coupled” and “connected” and their extended expressions may be used. For example, some embodiments may be described using the term “connected” to indicate that two or more elements are in direct physical contact or electrical contact with each other. For another example, the term “coupled” may be used in the description of some embodiments to indicate that two or more components are in direct physical or electrical contact. However, the term “coupled” or “communicatively coupled” may also mean that two or more elements are not in direct contact with each other, but still cooperate or interact with each other. The embodiments disclosed herein are not necessarily limited to the content herein.

The use of “applicable to” or “configured to” means an open and inclusive expression, which does not exclude apparatuses that are applicable to or configured to perform additional tasks or steps.

In addition, the use of “based on” is made in an open and inclusive sense, since a process, step, calculation or other action that is “based on” one or more of the said conditions or values may, in practice, be based on additional conditions or the ones exceeding the values.

As used herein, “about” or “approximately” includes the stated value and the average value that is within an acceptable deviation range of a specific value. The acceptable deviation range is determined by a person of ordinary skill in the art in view of measurement in question and errors associated with measurement of a specific quantity (i.e., limitations of a measurement system).

A gray scale represents luminance ranging from the brightest to the darkest is with a plurality of scales. More scales of the gray scale means more delicate screen effect that can be presented by a display.

In theory, each of three primary colors has same color coordinates at different gray scales. That is, red color coordinates at different gray scales are the same, green color coordinates at different gray scales are the same, and blue color coordinates at different gray scales are the same. In addition, in a range of all gray scales, the three primary colors at a same gray scale are mixed to form an achromatic color. That is, the three primary colors at the same gray scale are mixed to form achromatic colors such as black, gray and white, and color coordinates of these achromatic colors are the same.

However, in fact, color coordinates of the three primary colors at different gray scales are not identical due to a change in tristimulus values of the three primary colors, which causes a problem that color coordinates of the achromatic colors are also different.

In this case, the luminance is adjusted through a gamma correction. When the color coordinates of the achromatic colors formed by mixing the three primary colors at the same gray scale are inconsistent for respective gray scale, a phenomenon may occur that color temperatures of the display are inconsistent.

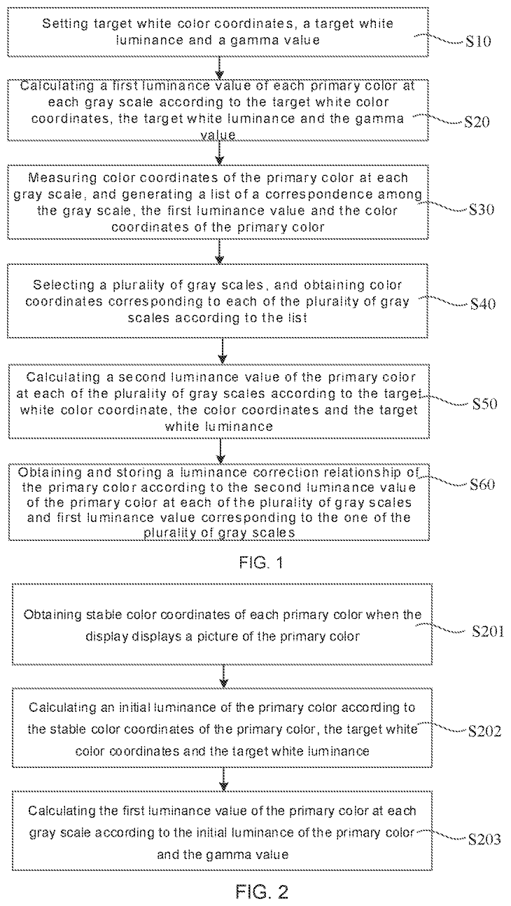

An embodiment of the present disclosure provides a method for obtaining luminance correction relationships of three primary colors, which includes S10 to S60 as shown in FIG. 1.

In S10, target white color coordinates, a target white luminance and a gamma value are set.

The target white color coordinates refer to color coordinates of achromatic colors that are formed by the three primary colors at a same one of all the gray scales, i.e., refer to theoretical same color coordinates from black to gray and then to white.

The target white luminance is a luminance corresponding to the same color coordinates when the display displays achromatic colors at different gray scales, i.e., a luminance corresponding to the target white color coordinates.

It will be noted that the target white color coordinates, the target white luminance and the gamma value may be set according to user requirements, which are not specifically limited herein.

In S20, a first luminance value of each primary color at each gray scale is calculated according to the target white color coordinates, the target white luminance and the gamma value.

For example, calculating the first luminance value of each primary color at each gray scale according to the target white color coordinates, the target white luminance and the gamma value includes S201 to S203 as shown in FIG. 2.

In S201, stable color coordinates of the primary color are obtained when the display displays a picture of the primary color.

For example, before the stable color coordinates of the primary color are obtained, a luminance measurement range corresponding to the picture of the primary color displayed by the display is selected empirically. Then, when the display displays the picture of the primary color, the luminance may be gradually increased in the luminance measurement range corresponding to the picture of the primary color while color coordinates at each luminance may be measured, until corresponding color coordinates of the primary color stabilize.

For example, in a case where the three primary colors are red, green and blue colors, their luminance measurement ranges are selected respectively corresponding to a case where a red picture, a green picture or a blue picture is displayed by the display. Then, when the display displays the red picture, the green picture or the blue picture, the luminance may be gradually increased in each corresponding luminance measurement range while corresponding color coordinates may be measured , until color coordinates corresponding to red, green and blue tend to stability, respectively.

It will be noted that, the luminance measurement range corresponding to the displayed picture of each primary color is required to be selected to be the one in which a change in color coordinates is significant.

For example, empirically, the red color coordinates have a significant change in a luminance range of 0 nit to 100 nit, and thus the red luminance measurement range is selected to be 0 nit to 100 nit. Then, a red luminance is adjusted by changing a magnitude of a driving voltage of the display, so that the red luminance gradually increases from 0 nit to 100 nit, e.g., increases by 10 nit each time. At the same time, the red color coordinates corresponding to different red luminances are sequentially recorded by using a luminance meter. Then, a difference between red color coordinates obtained in a current measurement and the ones obtained in a last measurement is calculated. As the red luminance increases, a red spectrum tends to stability. The red color coordinates become more and more stable, and the difference gradually decreases. In a case where the difference is less than or equal to a first threshold, the measurement ends. At this time, the red color coordinates measured by the luminance meter are used as stable red color coordinates.

For example, the first threshold is set as 0.01, and when the red luminance is 80 nit, the measured red color coordinates are (0.49, 0.52), and when the red luminance is 90 nit, the measured red color coordinates are (0.50, 0.52). At this time, a difference of the red color coordinates is: D=\sqrt{(0.50−0.49)²−(0.52−0.52)²}=0.01. The difference D is equal to the first threshold, and the measurement ends. The color coordinates (0.50, 0.52) are used as the stable red color coordinates.

Similarly, empirically, the green color coordinates have a significant change in a luminance range of 0 nit to 50 nit, and thus the green luminance measurement range is selected to be 0 nit to 50 nit. Then, a green luminance is adjusted by changing a magnitude of the driving voltage of the display. In this way, the green luminance gradually increases from 0 nit to 50 nit, e.g., increases by 5 nit each time. At the same time, the green color coordinates corresponding to different green luminances are sequentially recorded by using the luminance meter. Then, a difference between green color coordinates obtained in a current measurement and the ones obtained in a last measurement is calculated. As the green luminance increases, a green spectrum tends to stability. The green color coordinates become more and more stable, and the difference gradually decreases. In a case where the difference is less than or equal to a second threshold, the measurement ends, At this time, the green color coordinates measured by the luminance meter are used as stable green color coordinates.

Similarly, empirically, the blue color coordinates have a significant change in a luminance range of 20 nit to 40 nit, and thus the blue luminance measurement range is selected to be 20 nit to 50 nit. Then, a blue luminance is adjusted by changing a magnitude of the driving voltage of the display. In this way, the green luminance gradually increases from 20 nit to 40 nit, e.g., increases by 2 nit each time. At the same time, the blue color coordinates corresponding to different blue luminances are sequentially recorded by using the luminance meter. Then, a difference between blue color coordinates obtained in a current measurement and the ones obtained in a last measurement is calculated. As the blue luminance increases, a blue spectrum tends to stability. The blue color coordinates become more and more stable, and the difference gradually decreases. In a case where the difference is less than or equal to a third threshold, the measurement ends. At this time, the blue color coordinates measured by the luminance meter are used as stable blue color coordinates.

It will be noted that the luminance measurement ranges of the three primary colors may be different, and an increasing step for each luminance may also be different when the measurement is made in respective luminance ranges. In this case, the first threshold, the second threshold and the third threshold set above may be the same or different, which is not limited in the present disclosure.

In S202, an initial luminance of the primary color is calculated according to the stable color coordinates of the primary color, the target white color coordinates and the target white luminance.

For example, an initial ed luminance, an initial green luminance and an initial blue luminance are respectively calculated according to the stable red color coordinates, the stable green color coordinates and the stable blue color coordinates that are obtained, respectively in combination with the target white color coordinates and the target white luminance.

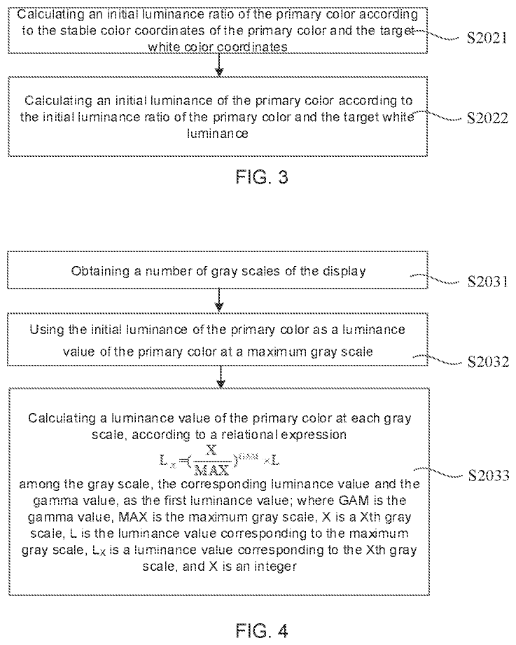

For example, calculating the initial luminance of the primary color according to the stable color coordinates of the primary color, the target white color coordinates and the target white luminance includes S2021 and S2022, as shown in FIG. 3.

In S2021, an initial luminance ratio of the primary color is calculated according to the stable color coordinates of the primary color and the target white color coordinates.

For example, an initial red luminance ratio, an initial green luminance ratio and an initial blue luminance ratio are respectively calculated according to the stable red color coordinates, the stable green color coordinates and the stable blue color coordinates, respectively in combination with the target white color coordinates,

Based on the CIE color space formulated by the international commission on illumination (CIE), it may be seen that in the CIE XYZ system, a relational expression between the three primary color coordinates and the luminance ratios is:

$$\begin{matrix}{P}_{R} = [ \frac{( \frac{{x}_{W} - {x}_{R}}{{x}_{G} - {x}_{R}} ) - ( \frac{{z}_{W} - {z}_{R}}{{z}_{G} - {z}_{R}} )}{\frac{{y}_{W}}{( \frac{{x}_{B} - {x}_{R}}{{x}_{G} - {x}_{R}} ) - ( \frac{{z}_{B} - {z}_{R}}{{z}_{G} - {z}_{R}} )}} ] \times {y}_{B} ; & ( 1 ) \\ {P}_{G} = \frac{{x}_{W} - {x}_{R}}{( {x}_{G} - {x}_{R} ) \times {y}_{W}} - [ \frac{( \frac{{x}_{W} - {x}_{R}}{{x}_{G} - {x}_{R}} ) - ( \frac{{z}_{W} - {z}_{R}}{{z}_{G} - {z}_{R}} )}{\frac{{y}_{W}}{( \frac{{x}_{B} - {x}_{R}}{{x}_{G} - {x}_{R}} ) - ( \frac{{z}_{B} - {z}_{R}}{{z}_{G} - {z}_{R}} )}} ] \times ( \frac{{x}_{B} - {x}_{B}}{{x}_{G} - {x}_{R}} ) ; & ( 2 ) \\ {P}_{B} = 1 - {P}_{R} - {P}_{G} . & ( 3 )\end{matrix}$$

Here, (x_{R}, y_{R}, x_{R}) are the red color coordinates in the CIE XYZ system, (x_{G}, y_{G}, z_{G}) are the green color coordinates in the CIE XYZ system, (x_{B}, y_{B}, z_{B}) are the blue color coordinates in the CIE XYZ system, (x_{W}, y_{W}, z_{W}) are the white color coordinates in CIE XYZ system, P_{R} is the red luminance ratio in the CIE XYZ system, P_{G} is the green luminance ratio in the CIE XYZ system, and P_{B} is the blue luminance ratio in the CIE XYZ system.

Moreover, coordinates in X, Y, and Z directions have the following relationships.

z_{W}=1−x_{W}−y_{W} (4);

z_{R}=1−x_{R}−y_{R} (5);

z_{G}=1−x_{G}−y_{G} (6);

z_{B}=1−x_{B}−y_{B} (7).

With the above formulas (4), (5), (6) and (7) substituted into the formulas (1), (2) and (3), a relationship between the color coordinates and the luminance ratios in the CIE XYZ system is converted into a relationship between color coordinates and luminance ratios in CIE xy system, which is as follows:

$$\begin{matrix}{P}_{R} = \{ \frac{( \frac{{x}_{W} - {x}_{R}}{{x}_{G} - {x}_{R}} ) - [ \frac{( 1 - {x}_{W} - {y}_{W} ) - ( 1 - {x}_{R} - {y}_{R} )}{( 1 - {x}_{G} - {y}_{G} ) - ( 1 - {x}_{R} - {y}_{R} )} ]}{\frac{{y}_{W}}{( \frac{{x}_{B} - {x}_{R}}{{x}_{G} - {x}_{R}} ) - [ \frac{( 1 - {x}_{B} - {y}_{B} ) - ( 1 - {x}_{R} - {y}_{R} )}{( 1 - {x}_{G} - {y}_{G} ) - ( 1 - {x}_{R} - {y}_{R} )} ]}} \} \times {y}_{B} ; & ( 8 ) \\ {P}_{G} = \frac{{x}_{W} - {x}_{R}}{( {x}_{G} - {x}_{R} ) \times {y}_{W}} - \{ \frac{( \frac{{x}_{W} - {x}_{R}}{{x}_{G} - {x}_{R}} ) - [ \frac{( 1 - {x}_{W} - {y}_{W} ) - ( 1 - {x}_{R} - {y}_{R} )}{( 1 - {x}_{G} - {y}_{G} ) - ( 1 - {x}_{R} - {y}_{R} )} ]}{\frac{{y}_{W}}{( \frac{{x}_{B} - {x}_{R}}{{x}_{G} - {x}_{R}} ) - [ \frac{( 1 - {x}_{B} - {y}_{B} ) - ( 1 - {x}_{R} - {y}_{R} )}{( 1 - {x}_{G} - {y}_{G} ) - ( 1 - {x}_{R} - {y}_{R} )} ]}} \} \times ( \frac{{x}_{B} - {x}_{B}}{{x}_{G} - {x}_{R}} ) ; & ( 9 ) \\ {P}_{B} = 1 - {P}_{R} - {P}_{G} . & ( 10 )\end{matrix}$$

For example, the target white color coordinates are set as (x_{w}, y_{w}) according to customer needs, and are substituted, together with the stable red color coordinates (xᵣ, yᵣ), the stable green color coordinates (x_{g}, y_{g}) and the stable blue color coordinates (x_{b}, y_{b}), into the formulas (8), (9) and (10). The following formulas are obtained:

$${P}_{r} = \{ \frac{( \frac{{x}_{w} - {x}_{r}}{{x}_{g} - {x}_{r}} ) - [ \frac{( 1 - {x}_{w} - {y}_{w} ) - ( 1 - {x}_{r} - {y}_{r} )}{( 1 - {x}_{g} - {y}_{g} ) - ( 1 - {x}_{r} - {y}_{r} )} ]}{\frac{{y}_{w}}{( \frac{{x}_{b} - {x}_{r}}{{x}_{g} - {x}_{r}} ) - [ \frac{( 1 - {x}_{b} - {y}_{b} ) - ( 1 - {x}_{r} - {y}_{r} )}{( 1 - {x}_{g} - {y}_{g} ) - ( 1 - {x}_{r} - {y}_{r} )} ]}} \} \times {y}_{B} ;$$

$${P}_{g} = \frac{{x}_{w} - {x}_{r}}{( {x}_{g} - {x}_{r} ) \times {y}_{w}} - \{ \frac{( \frac{{x}_{w} - {x}_{r}}{{x}_{g} - {x}_{r}} ) - [ \frac{( 1 - {x}_{w} - {y}_{w} ) - ( 1 - {x}_{r} - {y}_{r} )}{( 1 - {x}_{g} - {y}_{g} ) - ( 1 - {x}_{r} - {y}_{r} )} ]}{\frac{{y}_{w}}{( \frac{{x}_{b} - {x}_{r}}{{x}_{g} - {x}_{r}} ) - [ \frac{( 1 - {x}_{b} - {y}_{b} ) - ( 1 - {x}_{r} - {y}_{r} )}{( 1 - {x}_{g} - {y}_{Gg} ) - ( 1 - {x}_{r} - {y}_{r} )} ]}} \} \times ( \frac{{x}_{b} - {x}_{b}}{{x}_{g} - {x}_{r}} ) ;$$

$${P}_{b} = 1 - {P}_{r} - {P}_{g} .$$

As thus, calculated Pᵣ is the initial red luminance ratio, P_{g} is the initial green luminance ratio, and P_{b} is the initial blue luminance ratio.

In S2022, an initial luminance of the primary color is calculated according to the initial luminance ratio of the primary color and the target white luminance.

For example, an initial red luminance, an initial green luminance and an initial blue luminance are respectively calculated according to the initial red luminance ratio, the initial green luminance ratio, the initial blue luminance ratio, respectively in combination with the target white luminance.

The target white luminance is multiplied by the initial red luminance ratio, the initial green luminance ratio and the initial blue luminance ratio separately, so as to correspondingly obtain the initial red luminance, the initial green luminance and the initial blue luminance.

For example, the initial red luminance L_{R}, the initial green luminance L_{G}, and initial blue luminance L_{B} are calculated through L_{w}×Pᵣ=L_{R}, L_{w}×P_{g}=L_{G}, and L_{w}×P_{b}=L_{B}, respectively using the initial red luminance ratio Pᵣ, the initial green luminance ratio P_{g}, the initial blue luminance ratio P_{b}, the target white luminance L_{w}.

In S203, a first luminance value of the primary color at each gray scale is calculated according to the initial luminance of the primary color and the gamma value.

It will be understood that luminance values corresponding to the red, the green, and the blue at each gray scale are respectively calculated according to the initial red luminance, the initial green luminance, the initial blue luminance, and the gamma value.

For example, calculating the first luminance value of the primary color at each gray scale according to the initial luminance of the primary color and the gamma value includes S2031 to S2033.

In S2031, a number of the gray scales of the display is obtained.

For example, if the number of transmitted data bits of the display is 6, there are 2⁶ gray scales, and the gray scale value is in a range of 0 to 63. That is, the number of gray scales is 64. If the number of transmitted data of the display is 8, there are 2⁸ gray scales, and the gray scale value is in a range of 0 to 255. That is, the number of gray scales is 256. If the number of transmitted data of the display is 8, there are 2⁸ gray scales, and the gray scale value is in a range of 0 to 255. That is, the number of gray scales is 256.

In S2032, the initial luminance of the primary color is used as a luminance value of the primary color at a maximum gray scale.

It will be understood that the initial red luminance is used as a luminance value of the red at the maximum gray scale, the initial green luminance is used as the luminance value of the green at the maximum gray scale, and the initial blue luminance is used as a luminance value of the blue at the maximum gray scale.

For example, when the maximum gray scale of the display is 255, the initial red luminance L_{R}, the initial green luminance L_{G} and the initial blue luminance L_{B} that are calculated in S302 are used as luminance values corresponding to the red, the green and the blue at the 255th gray scale, respectively.

That is, the initial red luminance L_{R} is used as the luminance value of the red at the 255th gray scale, the initial green luminance L_{G} is used as the luminance value of the green at the 255th gray scale, and the initial blue luminance L_{B} is used as the luminance value of the blue at the 255th gray scale.

In S2033, a luminance value of the primary color at each gray scale is calculated according to a relational expression

$${L}_{X} = {( \frac{X}{MAX} )}^{GAM} \times L$$

among the gray scale, the luminance value and the gamma value as the first luminance value, where GAM is the gamma value, MAX is the maximum gray scale, X is an Xth gray scale, L is the luminance value corresponding to the maximum gray scale, L_{X} is a luminance value corresponding to the Xth gray scale, and X is an integer.

For example, the GAM is 2.2, the gray scale is in a range of 0 to 255, and 0≤X≤255.

For the red color, when the luminance value corresponding to the 255th gray scale is known to be L_{R}, according to the above relational expression, it is obtained:

$${L}_{RX} = {( \frac{X}{255} )}^{2.2} \times {L}_{R} . \qquad ( 11 )$$

For the green color, when the luminance value corresponding to the 255th gray scale is known to be L_{G}, according to the above relational expression, it is obtained:

$${L}_{GX} = {( \frac{X}{255} )}^{2.2} \times {L}_{G} . \qquad ( 12 )$$

For the blue color, when the luminance value corresponding to the 255th gray scale is known to be L_{B}, according to the above relational expression, it is obtained:

$${L}_{BX} = {( \frac{X}{255} )}^{2.2} \times {L}_{B} . \qquad ( 13 )$$

On this basis, when X is 0, the luminance value of the red, the luminance value of the green, and the luminance value of the blue at the zeroth gray scale are calculated to be L_{R0}, L_{G0}, and L_{B0} according to the formulas (11), (12) and (13) respectively.

When X is 150, the luminance value of the red, the luminance value of the green, and the luminance value of the blue at the zeroth gray scale are calculated to be L_{R150}, L_{G150}, and L_{B150} according to the formulas (11), (12) and (13) respectively.

When X is 255, the luminance value of the red, the luminance value of the green, and the luminance value of the blue at the zeroth gray scale are calculated to be L_{R255} (which is equal to the initial red luminance L_{R}), L_{G255} (which is equal to the initial green luminance L_{G}), and L_{B255} (which is equal to the initial blue luminance L_{B}) according to the formulas (11), (12) and (13) respectively.

In S30, the color coordinates of the primary color at each gray scale are measured, and a list of a correspondence among the gray scale, the first luminance value and the color coordinates of the primary color is generated.

It will be understood that the color coordinates of the red, the green, and the blue at each gray scale are measured respectively, and the lists of correspondence among the gray scale, the first luminance value and the color coordinates respectively for the red, the green and the blue are generated.

For example, in table 1, in a case where there are 256 gray scales for the display, the color coordinates of the red, the green and the blue at each gray scale are sequentially measured from the zeroth gray scale to the maximum gray scale (i.e., the 255th gray scale) by using the luminance meter. The lists of correspondence among the gray scale, the first luminance value and the color coordinates respectively for the red, of the green and the gray scale of the blue are generated.

TABLE 1

| Gray Scale | First Luminance Value | Color Coordinates |
|---|---|---|
| Zeroth Gray Scale | L_{R0}; L_{G0}; L_{B0} | (X_{R0}, Y_{R0}); (X_{G0}, Y_{G0}); |
| | | (X_{B0}, Y_{B0}) |
| 1st Gray Scale | L_{R1}; L_{G1}; L_{B1} | (X_{R1}, Y_{R1}); (X_{G1}, Y_{G1}); |
| | | (X_{B1}, Y_{B1}) |
| 2nd Gray Scale | L_{R2}; L_{G2}; L_{B2} | (X_{R2}, Y_{R2}); (X_{G2}, Y_{G2}); |
| | | (X_{B2}, Y_{B2}) |
| 3rd Gray Scale | L_{R3}; L_{G3}; L_{B3} | (X_{R3}, Y_{R3}); (X_{G3}, Y_{G3}); |
| | | (X_{B3}, Y_{B3}) |
| 4th Gray Scale | L_{R4}, L_{G4}, L_{B4} | (X_{R4}, Y_{R4}); (X_{G4}, Y_{G4}); |
| | | (X_{B4}, Y_{B4}) |
| . . . | . . . | . . . |
| 255th Gray Scale | L_{R}; L_{G}; L_{B} | (X_{R255}, Y_{R255}); |
| | | (X_{G255}, Y_{G255}); |
| | | (X_{B255}, Y_{B255}) |

It will be understood that, since the first luminance value of the primary color at each gray scale has been obtained, after the color coordinates at each gray scale are obtained, the list of one-to-one correspondence between the first luminance value and the color coordinates is established for each gray scale.

For example, the first luminance value and the color coordinates at each gray scale have a one-to-one correspondence in the list of the correspondence among the gray scale, the first luminance value and the color coordinates of the red; the first luminance value and the color coordinates at each gray scale have a one-to-one correspondence in the list of the correspondence among the gray scale, the first luminance value and the color coordinates of the green; and the first luminance value and the color coordinates at each gray scale have a one-to-one correspondence in the list of the correspondence among the gray scale, the first luminance value and the color coordinates of the blue.

In S40, a plurality of gray scales are selected, and color coordinates corresponding to each of the plurality of gray scales are obtained according to the list.

That is, R gray scales are selected, where R is greater than or equal to 2, and is a positive integer.

The plurality of gray scales selected may be continuous gray scales or discontinuous gray scales. For example, 10 gray scales of the 0 to 255 gray scales are selected. The 10 gray scales may be consecutive 10 gray scales from the 25th gray scale to the 34th gray scale. Or, the 10 gray scales may be selected from 0 to 255 gray scales in such a manner that one gray scale is selected every 25 gray scales. For example, a 25th gray scale, a 50th gray scale, a 75th gray scale . . . a 250th gray scale are selected in sequence.

In this case, red color coordinates, green color coordinates, and blue color coordinates at the R gray scales are obtained according to the above list.

In S50, a second luminance value of the primary color at each of the plurality of gray scales is calculated according to the target white color coordinates and the target white luminance.

It will be understood that a second red luminance value, a second green luminance value, and a second blue luminance value at each of the R gray scales are respectively calculated according to the target white color coordinates and the target white luminance.

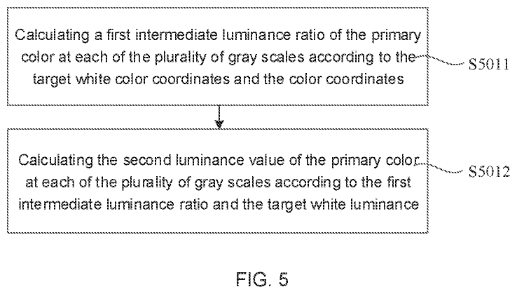

For example, calculating the second luminance value of the primary color at each of the plurality of gray scales according to the target white color coordinates, the color coordinates and the target white luminance includes S5011 to S5012 as shown in FIG. 5.

In S5011, a first intermediate luminance ratio of the primary color at each of the plurality of gray scales is calculated according to the target white color coordinates and the color coordinates.

It will be understood that, a first intermediate red luminance ratio, a first intermediate green luminance ratio, and a first intermediate blue luminance ratio at each of the R gray scales are respectively calculated according to the target white color coordinates, and the obtained red color coordinates, green color coordinates and blue color coordinates corresponding to the R gray scales.

For example, the red color coordinates, the green color coordinates and the blue color coordinates at each of the R gray scales are obtain by looking up the list in view of the selected gray scales.

Taking the 25th gray scale as an example, the red color coordinates are (x_{R25}, y_{R25}), the green color coordinates are (x_{G25}, y_{G25}), and the blue color coordinates are (x_{B25}, y_{B25}), which are obtained at the gray scale. The red color coordinates (x_{R25}, y_{R25}) , the green color coordinates (X_{G25}, y_{G25}), the blue color coordinates (X_{B25}, y_{B25}), and the set target white color coordinates (x_{w}, y_{w}) are substituted into the above formulas (8), (9) and (10), so as to obtain the first intermediate red luminance ratio, the first intermediate green luminance ratio and the first intermediate blue luminance ratio at the 25th gray scale, respectively as follows:

$${P}_{r 25} = \{ \frac{( \frac{{x}_{w} - {x}_{R 25}}{{x}_{G 25} - {x}_{R 25}} ) - [ \frac{( 1 - {x}_{w} - {y}_{w} ) - ( 1 - {x}_{R 25} - {y}_{R 25} )}{( 1 - {x}_{G 25} - {y}_{G 25} ) - ( 1 - {x}_{R 25} - {y}_{R 25} )} ]}{\frac{{y}_{w}}{( \frac{{x}_{B 25} - {x}_{R 25}}{{x}_{G 25} - {x}_{R 25}} ) - [ \frac{( 1 - {x}_{B 25} - {y}_{B 25} ) - ( 1 - {x}_{R 25} - {y}_{R 25} )}{( 1 - {x}_{G 25} - {y}_{G 25} ) - ( 1 - {x}_{R 25} - {y}_{R 25} )} ]}} \} \times {y}_{B} ;$$

$${P}_{g 25} = \frac{{x}_{w} - {x}_{R 25}}{( {x}_{G 25} - {x}_{R 25} ) \times {y}_{w}} - \{ \frac{( \frac{{x}_{w} - {x}_{R 25}}{{x}_{G 25} - {x}_{R 25}} ) - [ \frac{( 1 - {x}_{w} - {y}_{w} ) - ( 1 - {x}_{R 25} - {y}_{R 25} )}{( 1 - {x}_{G 25} - {y}_{G 25} ) - ( 1 - {x}_{R 2 \; 5} - {y}_{R25} )} ]}{\frac{{y}_{w}}{( \frac{{x}_{B 25} - {x}_{R 25}}{{x}_{G 25} - {x}_{R 25}} ) - [ \frac{( 1 - {x}_{B 25} - {y}_{B 25} ) - ( 1 - {x}_{R 25} - {y}_{R 25} )}{( 1 - {x}_{G 25} - {y}_{G 25} ) - ( 1 - {x}_{R 25} - {y}_{R 25} )} ]}} \} \times ( \frac{{x}_{B 25} - {x}_{R 25}}{{x}_{G 25} - {x}_{R 25}} ) ;$$

$${P}_{b 25} = 1 - {P}_{r 25} - {P}_{g 25} .$$

Here, Pᵣ₂₅ is the first intermediate red luminance ratio at the 25th gray scale, P_{g25} is the first intermediate green luminance ratio at the 25th gray scale, and P_{b25} is the first intermediate blue luminance ratio at the 25th gray scale.

Similarly, the first intermediate red luminance ratio, the first intermediate green luminance ratio and the first intermediate blue luminance ratio at each of the R gray scales (e.g., the 50th gray scale, the 75th gray scale . . . the 250th gray scale) may be calculated in sequence, which is not repeated herein again.

In S5012, the second luminance value of the primary color at each of the plurality of gray scales is calculated according to the first intermediate luminance ratio and the target white luminance.

It will be understood that the second red luminance value, the second luminance value and the second blue luminance value at each of the R gray scales are respectively calculated according to the first intermediate red luminance ratio, the first intermediate green luminance ratio and the first intermediate blue luminance ratio at each of the R gray scales, respectively in combination with the target white luminance.

For example, the second red luminance at the 25th gray scale is L′_{R25}, the second green luminance at the 25th gray scale is L′_{G25} and the second blue luminance at the 25th gray scale is L′_{B25}, which are calculated according to the first intermediate red luminance ratio Pᵣ₂₅, the first intermediate green luminance ratio P_{g25}, the first intermediate blue luminance ratio P_{b25} at the 25th gray scale and the set target white luminance L_{w} of the display, and through L_{w}×Pᵣ₂₅=L′_{R25}, L_{w}×P_{g25}=L′_{G25}, L_{w}×P_{b25}=L′_{B25}.

Similarly, the second red luminance value, the second green luminance value and the second blue luminance value at each gray scale are calculated according to the first intermediate red luminance ratio, the first intermediate green luminance ratio and the first intermediate blue luminance ratio at each of the R gray scales (e.g., the 50th gray scale, the 75th gray scale . . . the 250th gray scale), respectively in combination with the set target white luminance L_{w} of the display.

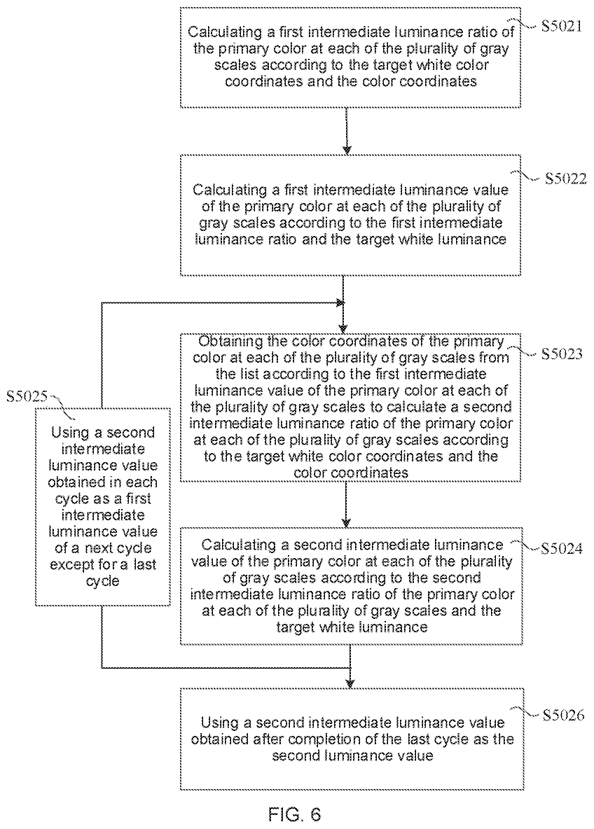

Or, for example, calculating the second luminance value of the primary color at each of the plurality of gray scales according to the target white color coordinates, the color coordinates and the target white luminance includes S5021 to S5026 as shown in FIG. 6.

In S5021, a first intermediate luminance ratio of the primary color at each of the plurality of gray scales is calculated according to the target white color coordinates and the color coordinates.

It will be understood that the first intermediate red luminance ratio, the first intermediate green luminance ratio and the first intermediate blue luminance ratio at each of the R gray scales are respectively calculated according to the red color coordinates, the green color coordinates and the blue color coordinates at each of the R gray scales that are obtained in the list, respectively, in combination with the target white color coordinates.

For example, the red color coordinates, the green color coordinates and the blue color coordinates at each of the R gray scales are obtain by looking up the list in view of the selected gray scales. The target white coordinates (x_{w}, y_{w}) are substituted into formulas (8), (9) and (10), so as to calculate the first intermediate red luminance ratio, the first intermediate green luminance ratio and the first intermediate blue luminance ratio at each of the R gray scales in sequence.

In S5022, a first intermediate luminance value of the primary color at each of the plurality of gray scales is calculated according to the first intermediate luminance ratio and the target white luminance.

It will be understood that the first intermediate red luminance value, the first intermediate green luminance value and the first intermediate blue luminance value at each of the R gray scales are respectively calculated according to the first intermediate red luminance ratio, the first intermediate green luminance ratio and the first intermediate blue luminance ratio at each of the R gray scales, respectively in combination with the target white luminance.

For example, the first intermediate red luminance value, the first intermediate green luminance value and the first intermediate blue luminance value at each of the R gray scales are obtained by respectively multiplying the first intermediate red luminance ratio, the first intermediate green luminance ratio and the first intermediate blue luminance ratio at each of the R gray scales by the set target white luminance L_{w} of the display.

On this basis, the following steps S5023 to S5025 are cycled at least once.

In S5023, the color coordinates of the primary color at each of the plurality of gray scales are obtained from the list according to the first intermediate luminance value of the primary color at each of the plurality of gray scales to calculate a second intermediate luminance ratio of the primary color at each of the plurality of gray scales according to the target white color coordinates and the color coordinates.

It will be understood that the red color coordinates, the green color coordinates and the blue color coordinates at each of the R gray scales are respectively obtained from the list according to the first intermediate red luminance, the first intermediate green luminance and the first intermediate blue luminance at each of the R gray scales to calculate the second intermediate red luminance ratio, the second intermediate green luminance ratio and the second intermediate blue luminance ratio at each of the R gray scales combined with the target white color coordinates.

For example, at the 25th gray scale, the second red luminance is L′_{R25}, the second green luminance is L′_{R25} and the second blue luminance is L′_{B25}. At the 25th gray scale, the red color coordinates are (x′_{R25}, y′_{R25}), the green color coordinates are (x′_{G25}, y′_{G25}) and the blue coordinates are (x′_{B25}, y′_{B25}), which are obtained from the list. The set target white color coordinates are (x_{w}, y_{w}). The second intermediate red luminance ratio, the second intermediate green luminance ratio and the second intermediate blue luminance ratio at the 25th gray scale are obtained according to the formulas (8), (9) and (10), respectively as follows:

$${P}_{r 25}^{′} = \{ \frac{( \frac{{x}_{w} - {x}_{R 25}^{′}}{{x}_{G 25}^{′} - {x}_{R 25}^{′}} ) - [ \frac{( 1 - {x}_{w} - {y}_{w} ) - ( 1 - {x}_{R 25}^{′} - {y}_{R 25}^{′} )}{( 1 - {x}_{G 25}^{′} - {y}_{G 25}^{′} ) - ( 1 - {x}_{R 25}^{′} - {x}_{R 25}^{′} )} ]}{\frac{{y}_{w}}{( \frac{{x}_{B 25}^{′} - {x}_{R 25}^{′}}{{x}_{G 25}^{′} - {x}_{G 25}^{′}} ) - [ \frac{( 1 - {x}_{B 25}^{′} - {y}_{B 25}^{′} ) - ( 1 - {x}_{R 25}^{′} - {y}_{G 25}^{′} )}{( 1 - {x}_{G 25}^{′} - {y}_{G 25}^{′} ) - ( 1 - {x}_{G 25}^{′} - {y}_{R 25}^{′} )} ]}} \} \times {y}_{B 25}^{′} ;$$

$${P}_{g 25}^{′} = \frac{{x}_{w} - {x}_{GR25}^{′}}{( {x}_{G 25}^{′} - {x}_{R 25}^{′} ) \times {y}_{w}} - \{ \frac{( \frac{{x}_{w} - {x}_{R 25}^{′}}{{x}_{G 25}^{′} - {x}_{R 25}^{′}} ) - [ \frac{( 1 - {x}_{w} - {y}_{w} ) - ( 1 - {x}_{R 25}^{′} - {y}_{R 25}^{′} )}{( 1 - {x}_{G 25}^{′} - {y}_{G 25}^{′} ) - ( 1 - {x}_{R 25}^{′} - {y}_{R 25}^{′} )} ]}{\frac{{y}_{w}}{( \frac{{x}_{B 25}^{′} - {x}_{R 25}^{′}}{{x}_{G 25}^{′} - {x}_{R 25}^{′}} ) - [ \frac{( 1 - {x}_{B 25}^{′} - {y}_{B 25}^{′} ) - ( 1 - {x}_{R 25}^{′} - {x}_{ R 25}^{′} )}{( 1 - {x}_{G 25}^{′} - {y}_{G 25}^{′} ) - ( 1 - {x}_{R 25}^{′} - {y}_{R 2 \; 5}^{′ } )} ]}} \} \times ( \frac{{x}_{B 25}^{′} - {x}_{R 25}^{′}}{{x}_{G 25}^{′} - {x}_{R 25}^{′}} ) ; \\ {P}_{b 25}^{′} = 1 - {P}_{r 25}^{′} - {P}_{g 25}^{′} .$$

Here, P′ᵣ₂₅ is the second intermediate red luminance ratio at the 25th gray scale, P′_{g25} is the second intermediate green luminance ratio at the 25th gray scale, and P′_{b25} is the second intermediate blue luminance ratio at the 25th gray scale.

Similarly, the second intermediate red luminance ratio, the second intermediate green luminance ratio and the second intermediate blue luminance ratio at each of the R gray scales (e.g., the 50th gray scale, the 75th gray scale, until the 250th gray scale) may be calculated in sequence, which is not repeated herein again.

In S5024, a second intermediate luminance value of the primary color at each of the plurality of gray scales is calculated according to the second intermediate luminance ratio of the primary color at each of the plurality of gray scales and the target white luminance.

It will be understood that a second intermediate red luminance value, a second intermediate green luminance value and a second intermediate blue luminance value at each of the R gray scales are respectively calculated according to the second intermediate red luminance ratio, the second intermediate green luminance ratio and the second intermediate blue luminance ratio at each of the R gray scales, respectively in combination with the target white luminance.

For example, the second intermediate red luminance value at the 25th gray scale is L″_{R25}, the second intermediate green luminance value at the 25th gray scale is L″_{G25} and the second intermediate blue luminance value at the 25th gray scale is L″_{B25}, which are calculated according to the second intermediate red luminance ratio P′ᵣ₂₅, the second intermediate green luminance ratio P′_{g25}, the second intermediate blue luminance ratio P′_{b25} at the 25th gray scale, respectively in combination with the set target white luminance L_{w} of the display, and through L_{w}×P′ᵣ₂₅=L″_{R25}, L_{w}×P′_{g25}=L″_{G25}, L_{w}×P′_{b25}=L″_{B25}.

Similarly, the second intermediate red luminance value, the second intermediate green luminance value and the second intermediate blue luminance value at each of the R gray scales are calculated according to the second intermediate red luminance ratio, the first intermediate green luminance ratio and the first intermediate blue luminance ratio at each of the R gray scales (e.g., the 50th gray scale, the 75th gray scale . . . the 250th gray scale), respectively in combination with the set target white luminance L_{w} of the display.

In S5025, a second intermediate luminance value obtained in each cycle is used as a first intermediate luminance value of a next cycle except for a last cycle.

For example, except for the last cycle, a second intermediate red luminance value, a second intermediate green luminance value, and a second intermediate blue luminance value obtained in each cycle are used as a first intermediate red luminance value, a first intermediate green luminance value and a first intermediate blue luminance value of a next cycle, respectively.

It will be understood that, except for a first cycle, a second intermediate luminance value obtained in a previous cycle is used as the first intermediate luminance value in each cycle. For example, except for the first cycle, in each cycle, the second intermediate red luminance value, the second intermediate green luminance value and the second intermediate blue luminance value that are obtained in the previous cycle are used as the first intermediate red luminance value, the first intermediate green luminance value and the first intermediate blue luminance value, respectively.

For example, when a cycle is to be performed again after S5024. The obtained second intermediate red luminance value at each of the R gray scales (e.g., the 25th gray scale, the 50th gray scale, the 75th gray scale . . . the 250th gray scale) is used as the first intermediate red luminance value, the obtained second intermediate green luminance value at each of the R gray scales is used as the first intermediate green luminance value, and the obtained second intermediate blue luminance value at each of the R gray scales is used as the first intermediate blue luminance value. Then a calculation process is performed according to S5023 and S5024.

It will be noted that the number of cycles may be set according to requirements and is not limited here.

In S5026, a second intermediate luminance value obtained after completion of the last cycle is used as the second luminance value.

It will be understood that, after the last cycle is completed, the second intermediate red luminance value, the second intermediate green luminance value and the second intermediate blue luminance value obtained are used as the second red luminance value, the second green luminance value and the second blue luminance value, respectively.

For example, after the last cycle is completed, the second intermediate red luminance value at the 25th gray scale is L″″_{R25}, and L″″_{R25} is used as the second red luminance value at the 25th gray scale. The second intermediate green luminance value at the 25th gray scale is L″″_{G25}, and L″″_{G25} is used as the second green luminance value at the 25th gray scale, The second intermediate blue luminance value at the 25th gray scale is L″″_{B25}, and L″″_{B25} is used as the second blue luminance at the 25th gray scale.

Similarly, the second intermediate red luminance value, the second intermediate green luminance value and the second intermediate blue luminance value at each of the R gray scales (e.g., the 50th gray scale, the 75th gray scale . . . the 250th gray scale) are used as the second red luminance value, the second green luminance value, and the second blue luminance value at each gray scale, respectively.

In S60, a luminance correction relationship of the primary color is obtained and stored according to the second luminance value of the primary color at each of the plurality of gray scales and first luminance value corresponding to the one of the plurality of gray scales.

It will be understood that a luminance correction relationship of the red is obtained and stored according to the second red luminance value at each of the R gray scales and the first red luminance value at each of the R gray scales; a luminance correction relationship of the green is obtained and stored according to the second green luminance value at each of the R gray scales and the first green luminance value at each of the R gray scales; and a luminance correction relationship of the blue is obtained and stored according to the second blue luminance value at each of the R gray scales and the first blue luminance value at each of the R gray scales.

In summary, in the method for obtaining the luminance correction relationships of the three primary colors provided in the embodiments of the present disclosure, the first luminance value of each primary color at each gray scale is calculated according to the set target white color coordinates, the target white luminance and the gamma value, the color coordinates of the primary color at each gray scale are measured, and the list of the correspondence among the gray scale, and the first luminance value and the color coordinates of the primary color is generated. Then, the plurality of gray scales are selected, and the color coordinates corresponding to each of the plurality of gray scales are obtained according to the list. The second luminance value of the primary color at each of the plurality of gray scales is calculated according to the target white color coordinates and target white luminance. The luminance correction relationship of the primary color is obtained and stored according to the second luminance value of the primary color at each of the plurality of gray scales and the first luminance value corresponding to each of the plurality of gray scales. In this way, the luminance correction relationships of the three primary colors may be obtained simply and quickly. In correcting the luminance of the three primary colors of the display, the luminance correction relationships of the three primary colors are used to keep the white color temperature of the display consistent.

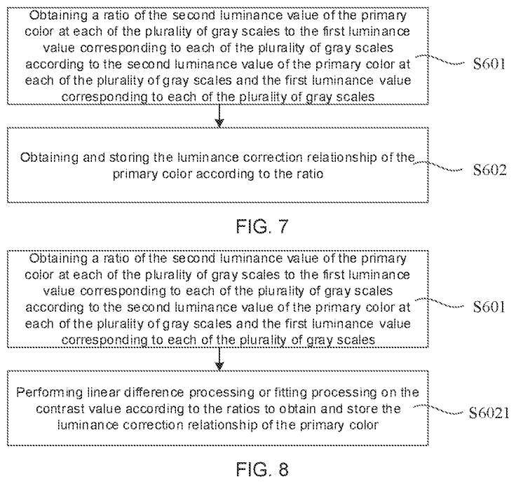

For example, obtaining and storing the luminance correction relationship of the primary color according to the second luminance value of the primary color at each of the plurality of gray scales and the first luminance value corresponding to each the plurality of gray scales include S601 and S602 as shown in FIG. 7.

In S601, a ratio of the second luminance value of the primary color at each of the plurality of gray scales to the first luminance value corresponding to each of the plurality of gray scales is obtained according to the second luminance value of the primary color at each of the plurality of gray scales and the first luminance value corresponding to each of the plurality of gray scales.

In S602, the luminance correction relationship of the primary color is obtained and stored according to the ratio.

It will be understood that a first ratio of the second red luminance value to the first red luminance value at each of the R gray scales is obtained according to the second red luminance value at each of the R gray scales and the first red luminance value at each of the R gray scales. The luminance correction relationship of the red is obtained and stored according to the first ratio.

A second ratio of the second green luminance value to the first green luminance value at each of the R gray scales is obtained according to the second green luminance value at each of the R gray scales and the first green luminance value at each of the R gray scales. The luminance correction relationship of the green is obtained and stored according to the second ratio.

A third ratio of the second blue luminance value to the first blue luminance value at each of the R gray scales is obtained according to the second blue luminance value at each of the R gray scales and the first blue luminance value at each of the R gray scales. The luminance correction relationship of the blue is obtained and stored according to the third ratio.

For example, obtaining and storing the luminance correction relationship of the primary color according to the ratios includes S601 and S6021 as shown in FIG. 8.

In S6021, a linear interpolation processing or fitting processing is performed on the ratio to obtain and store the luminance correction relationship of the primary color.

It will be understood that, a linear interpolation processing or fitting processing is performed on the first ratio of the red to obtain and store the luminance correction relationship of the red; a linear difference processing or fitting processing is performed on the second ratio of the green to obtain and store the luminance correction relationship of the green; and a linear difference processing or fitting processing is performed on the third ratio of the blue to obtain and store the luminance correction relationship of the blue.

For example, the first ratio of the second red luminance value L′_{R25} to the first red luminance value L_{R25} at the 25th gray scale is obtained to be

$$\frac{{L}_{R 25}^{′}}{{L}_{R 25}}$$

according to the second red luminance value L′_{R25} at the 25th gray scale and the first red luminance value L_{R25} at the 25th gray scale.

The second ratio of the second green luminance value L′_{G25} to the first green luminance value L_{G25} at the 25th gray scale is obtained to be

$$\frac{{L}_{G 25}^{′}}{{L}_{G 25}}$$

according to the second green luminance value L′_{G25} at the 25th gray scale and the first green luminance value L_{R25} at the 25th gray scale.

The third ratio of the second blue luminance value L′_{B25} to the first blue luminance value L_{B25} at the 25th gray scale is obtained to be

$$\frac{{L}_{B 25}^{′}}{{L}_{B 25}}$$

according to the second blue luminance value L′_{B25} at the 25th gray scale and the first blue luminance value L_{B25} at the 25th gray scale.

Similarly, it is obtained that, at the 50th gray scale, the first ratio is

$$\frac{{L}_{R 50}^{′}}{{L}_{R 50}} ,$$

the second ratio is

$$\frac{{L}_{G 50}^{′}}{{L}_{G 50}} ,$$

and the third ratio is

$$\frac{{L}_{B 50}^{′}}{{L}_{B 50}} .$$

Analogically, the first ratio, the second ratio and the third ratio at the 75th gray scale . . . the 250th gray scale are obtained.

In this case, the first ratios of the red corresponding to the 25th gray scale, the 50th gray scale, the 75th gray scale . . . the 250th gray scale are obtained to be

$$\frac{{L}_{R 25}^{′}}{{L}_{R 25}} , \frac{{L}_{R 50}^{′}}{{L}_{R 50}} , \frac{{L}_{R 75}^{′}}{{L}_{R 75}} … \frac{{L}_{R 250}^{′}}{{L}_{R 250}} ,$$

respectively. The linear difference processing or the fitting processing is performed on the first ratios, so as to obtain and store the luminance correction relationship of the red L′_{RX}=F(L_{RX}), where F(L_{RX}) is a function of L_{RX}.

Similarly, the second ratios of the green corresponding to the 25th gray scale, the 50th gray scale, the 75th gray scale . . . the 250th gray scale are obtained to be

$$\frac{{L}_{G 25}^{′}}{{L}_{G 25}} , \frac{{L}_{G 50}^{′}}{{L}_{G 50}} , \frac{{L}_{G 75}^{′}}{{L}_{G 75}} … \frac{{L}_{G 250}^{′}}{{L}_{G 250}} ,$$

respectively. The linear difference processing or the fitting processing is performed on the second ratios, so as to obtain and store the luminance correction relationship of the green L′_{GX}=F(L_{GX}), where F(L_{GX}) is a function of L_{GX}.

Similarly, the third ratios of the blue corresponding to the 25th gray scale, the 50th gray scale, the 75th gray scale . . . the 250th gray scale are obtained to be

$$\frac{{L}_{B 25}^{′}}{{L}_{B 25}} , \frac{{L}_{B 50}^{′}}{{L}_{B 50}} , \frac{{L}_{B 75}^{′}}{{L}_{B 75}} … \frac{{L}_{B 250}^{′}}{{L}_{B 250}} ,$$

respectively. The linear difference processing or the fitting processing is performed on the third ratios, so as to obtain and store the luminance correction relationship of the blue L′_{BX}=F(L_{BX}), where F(L_{BX}) is a function of L_{BX}.

Or, for example, after the last cycle is completed, the obtained second intermediate red luminance value L″″_{R25} at the 25th away scale is used as the second red luminance value, and combined with the first red luminance value L_{R25} at the 25th gray scale, the first ratio of the second red luminance value L″″_{R25} to the first red luminance value L_{R25} at the 25th gray scale is obtained to be

$$\frac{{L}_{R 25}^{′′′′}}{{L}_{R 25}} .$$

The second intermediate green luminance value L″″_{G25} at the 25th gray scale is used as the second green luminance value, and combined with the first green luminance value L_{G25} at the 25th gray scale, the second ratio of the second green luminance value L″″_{G25} to the first green luminance value L_{G25} at the 25th gray scale is obtained to be

$$\frac{{L}_{G 25}^{′′′′}}{{L}_{G 25}} .$$

The second intermediate blue luminance value L″″_{B25} at the 25th gray scale is used as the second blue luminance value, and combined with the first blue luminance value L_{B25} at the 25th gray scale, the third ratio of the second blue luminance value L″″_{B25} to the first blue luminance value L_{B25} at the 25th gray scale is obtained to be

$$\frac{{L}_{B 25}^{′′′′}}{{L}_{B 25}} .$$

Similarly, it is obtained that, at the 50th gray scale, the first ratio is t,?

, the second ratio is

$$\frac{{L}_{G 50}^{′′′′}}{{L}_{G 50}} ,$$

and the third ratio is

$$\frac{{L}_{B 50}^{′′′′}}{{L}_{B 50}} .$$

Analogically, the first ratio, the second ratio and the third ratio at the 75th gray scale . . . the 250th gray scale are obtained.

On this basis, the first ratios of the red corresponding to the 25th gray scale, the 50th gray scale, the 75th gray scale . . . the 250th gray scale are obtained to be

$$\frac{{L}_{R 25}^{′′′′}}{{L}_{R 25}} , \frac{{L}_{R 50}^{′′′′}}{{L}_{R 50}} , \frac{{L}_{R 75}^{′′′′}}{{L}_{R 75}} … \frac{{L}_{R 250}^{′′′′}}{{L}_{R 250}} ,$$

respectively. The linear difference processing or the fitting processing is performed on the first ratios, so as to obtain and store the luminance correction relationship of the red L″″_{RX}=F(L_{RX}), where F(L_{RX}) is a function of L_{RX}.

Similarly, the second ratios of the green corresponding to the 25th gray scale, the 50th gray scale, the 75th gray scale . . . the 250th gray scale are obtained to be

$$\frac{{L}_{G 25}^{′′′′}}{{L}_{G 25}} , \frac{{L}_{G 50}^{′′′′}}{{L}_{G 50}} , \frac{{L}_{G 75}^{′′′′}}{{L}_{G 75}} … \frac{{L}_{G 250}^{′′′′}}{{L}_{G 250}} ,$$

respectively. The linear difference processing or the fitting processing is performed on the second ratios, so as to obtain and store the luminance correction relationship of the green L″″_{GX}=F(L_{GX}), where F(L_{GX}) is a function of L_{GX}.

Similarly, the third ratios of the blue corresponding to the 25th gray scale, the 50th gray scale, the 75th gray scale . . . the 250th gray scale are obtained to be

$$\frac{{L}_{B 25}^{′′′′}}{{L}_{B 25}} , \frac{{L}_{B 50}^{′′′′}}{{L}_{B 50}} , \frac{{L}_{B 75}^{′′′′}}{{L}_{B 75}} … \frac{{L}_{B 250}^{′′′′}}{{L}_{B 250}} ,$$

respectively. The linear difference processing or the fitting processing is performed on the third ratios, so as to obtain and store the luminance correction relationship of the blue L″″_{BX}F(L_{BX}), where F(L_{BX}) is a function of L_{BX}.

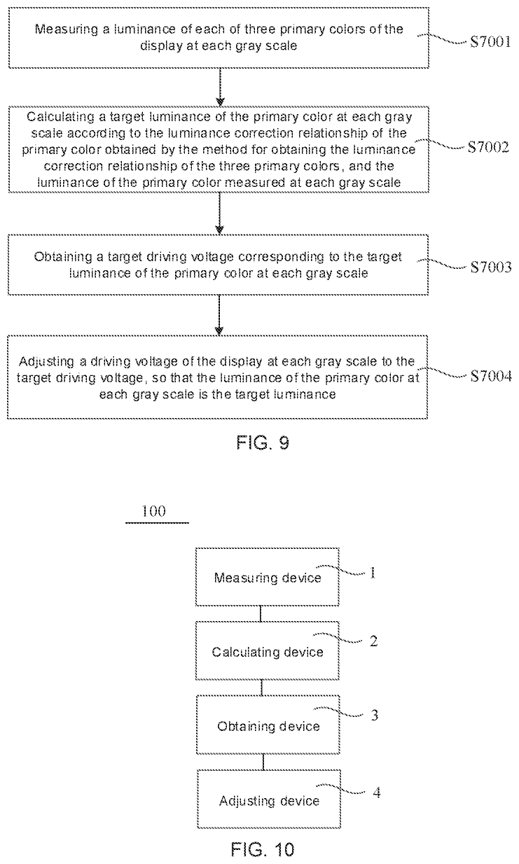

Embodiments of the present disclosure provide a correction method of a display the method includes S7001 to S7004 as shown in FIG. 9.

In S7001, a luminance of each of three primary colors of the display at each gray scale is measured.

The three primary colors are red, green and blue colors. In this case, a red luminance, a green luminance and a blue luminance of the display at each gray scale are measured.

In S7002, a target luminance of the primary color at each gray scale is calculated according to the luminance correction relationship of the primary color obtained by the method for obtaining the luminance correction relationships of the three primary colors, and the luminance of the primary color measured at each gray scale.

It will be understood that, the target red luminance, the target green luminance and the target blue luminance at each gray scale are respectively calculated according to the luminance correction relationship of the red, the luminance correction relationship of the green and the luminance correction relationship of the blue that are obtained by the method for obtaining the luminance correction relationships of the three primary colors, respectively in combination with the red luminance, the green luminance and the blue luminance that are measured at each gray scale.

In S7003, a target driving voltage corresponding to the target luminance of the primary color at each gray scale is obtained.

It will be understood that the target driving voltages corresponding to the target red luminance, the target green luminance and the target blue luminance at each gray scale are obtained respectively.

It will be noted that, in the method for obtaining the luminance correction relationships of the three primary colors, the driving voltage in the driving circuit may be recorded simultaneously in generating a list of the correspondence among the gray scale, the first luminance value and the color coordinates of the primary color, so that a one-to-one correspondence among the first luminance value, the color coordinates of the primary color and the driving voltage at each gray scale is established. In this case, the target driving voltage corresponding to the target luminance at each gray scale may be obtained by looking up the list for a driving voltage corresponding to the first luminance value at each gray scale.

For example, as for the gray scale of the red, the gray scale of the green and the gray scale of the blue, the driving voltage in the driving circuit may be recorded in generating a list of a correspondence between the first luminance value and the color coordinates, so that the list of the correspondence among the first luminance value, the color coordinates and the driving voltage of each of the red, the green and the blue at each gray scale is established. In this case, the list is looked up according to the target red luminance, the target green luminance and the target blue luminance at each gray scale, so as to obtain the target driving voltages corresponding to the target red luminance, the target green luminance and the target blue luminance at each gray scale through the correspondence, respectively.

It will be noted that, in addition to the above, those skilled in the art may also establish the correspondence between the luminance value of the primary color and the driving voltage at each gray scale in other manners, which is not limited in embodiments of the present disclosure.

In S7004, a driving voltage of the display at each gray scale is adjusted to the target driving voltage, so that the luminance of the primary color at each gray scale is the target luminance.

For example, the driving voltage of the display at each gray scale is adjusted to the target driving voltage, so that the red luminance at each gray scale is the target red luminance, the green luminance at each gray scale is the target green luminance, and the blue luminance at each gray scale is the target blue luminance.

It will be understood that, in a case where the red luminance at each gray scale is the target red luminance, the green luminance at each gray scale is the target green luminance, and the blue luminance at each gray scale is the target blue luminance, color coordinates of an achromatic color formed by mixing the three primary colors at the gray scale are consistent or approximately consistent with the target white color coordinates. Therefore, for all the gray scales of the display, color coordinates of all achromatic colors are corrected to consistent color coordinates, so that the white color temperature of the display remains consistent.

On this basis, in the correction method of the display provided by embodiments of the present disclosure, the luminance correction relationship of the primary color is obtained by the method for obtaining the luminance correction relationships of the three primary colors. The target luminance of the primary color at each gray scale is calculated according to the luminance of the primary color measured at each gray scale. The driving voltage of the display at each gray scale is adjusted to the target driving voltage which corresponds to the target luminance of the primary color obtained at each gray scale, so that the luminance of the primary color at each gray scale is the target luminance. In this way, the color coordinates of the achromatic color formed by mixing the three primary colors of the display at each gray scale remains consistent, so that the white color temperature of the display remains consistent.

Embodiments of the present disclosure provide a correction apparatus 100 of a display. As shown in FIG. 10, the correction apparatus 100 includes a measuring device 1, a calculating device 2, an obtaining device 3 and an adjusting device 4.

The calculating device 2 is coupled with the measuring device 1. The obtaining device 3 is coupled with the computing device 2. The adjusting device 4 is coupled with the obtaining device 3.

The measuring device 1 is configured to measure a luminance of each of three primary colors of the display at each gray scale.

It will be understood that, in a case where the three primary colors are red, green and blue colors, the measuring device 1 measures a red luminance, a green luminance and a blue luminance of the display at each gray scale.

For example, the measuring device 1 may be a luminance meter.

The calculating device 2 is configured to calculate a target luminance of a primary color at each gray scale according to the luminance correction relationship of the primary color obtained by the method for obtaining the luminance correction relationships of the three primary colors described in any one of the above embodiments, and the luminance of the primary color measured at each gray scale.

It will be understood that, the calculating device 2 calculates the target red luminance, the target green luminance and the target blue luminance at each gray scale according to a luminance correction relationship of the red, a luminance correction relationship of the green and a luminance correction relationship of the blue, respectively in combination with the red luminance, the green luminance and the blue luminance that are measured at each gray scale.

The obtaining device 3 is configured to obtain a target driving voltage corresponding to a target luminance of the primary color at each gray scale.

It will be understood that the obtaining device 3 obtains target driving voltages corresponding to the target red luminance, the target green luminance and the target blue luminance at each gray scale, respectively.

The adjusting device 4 is configured to adjust the driving voltage of the display at each gray scale to the target driving voltage, so that the luminance of the primary color at each gray scale is the target luminance.

It will be understood that the adjusting device 4 adjusts the driving voltage of the display at each gray scale to the target driving voltage, so that the red luminance at each gray scale is the target red luminance, and the green luminance at each gray scale is the target green luminance, and the blue luminance at each gray scale is the target blue luminance.

For example, the calculating device 2, the obtaining device 3 and the adjusting device 4 may all be a processor, or may be a collection of a plurality of processing elements. For example, the processor may be a central processing unit (CPU), an application specific integrated circuit (ASIC), or one or more integrated circuits configured to implement the embodiments of the present disclosure, such as one or more microprocessors (digital signal processors, DSP), or one or more field programmable gate arrays (FPGA).

Some embodiments of the present disclosure provide a display device 300. As shown in FIG. 11, the display device 300 includes the correction apparatus 100 as described in the above embodiments and a display 200. The display 200 is coupled with the correction apparatus 100.

It will be understood that, the display apparatus 300 can be any device that displays an image, moving (for example a video) or still (for example a static image), literal or graphical. More specifically, it is contemplated that the described embodiments may be implemented in or associated with a variety of electronic devices. The variety of electronic devices may include (but not limit to), for example, mobile telephones, wireless devices, portable android devices (PAD), hand-held or portable computers, global positioning system (GPS) receivers/navigators, cameras, MPEG-4 Part 14 (MP4) video players, a vidicon, game consoles, watches, clocks, calculators, TV monitors, flat panel displays, computer monitors, car displays (e.g., odometer display), navigators, cockpit controllers and/or displays, camera view displays (e.g., a rear view camera display in a vehicle), electronic photos, electronic billboards or signages, projectors, building structures, packaging and aesthetic structures (e.g., a display for an image of a piece of jewelry).

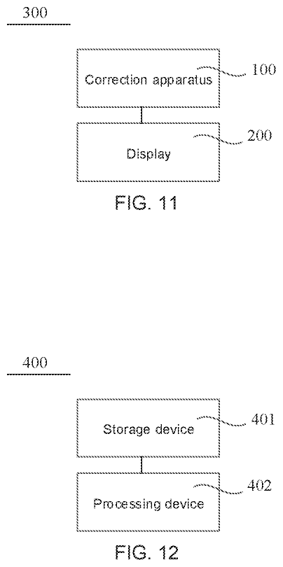

Embodiments of the present disclosure provide an electronic apparatus 400. As shown in FIG. 12, the electronic apparatus 400 includes a storage device 401 and a processing device 402.

The storage device 401 is coupled with the processing device 402.

The storage device 401 stores one or more computer programs that may be executed on the processing device 402.

When the processing device 402 executes the computer programs, one or more steps of the method for obtaining the luminance correction relationship in any one of the above embodiments are implemented; or one or more steps of the correction method in the above embodiments are implemented.

For example, the processing device 402 may be a processor, or may be a collection of a plurality of processing elements. For example, the processing device 402 may be a central processing unit, a specific integrated circuit, or one or more integrated circuits configured to implement the embodiments of the present disclosure, such as one or more microprocessors, or one or more field programmable gate arrays.

The storage device 402 may be a memory or a collection of a plurality of storage elements, and is used to store executable program codes. Moreover, the storage device 402 may include a random access memory (RAM) or a non-volatile memory, such as a disk memory, and a flash memory.

Some embodiments of the present disclosure provide a computer-readable storage medium (e,g, a non-transitory computer-readable storage medium). The computer-readable storage medium has stored computer program instructions therein. When the computer program instructions are executed by the processor, one or more steps of the method for obtaining the luminance correction relationship in any one of the above embodiments are implemented, or one or more steps of the correction method in the above embodiments are implemented.

For example, the computer-readable storage medium may include, but is not limited to: a magnetic storage device (e.g., a hard disk, a floppy disk or a magnetic tape, etc.), an optical disk (e.g., a compact disk (CD), a digital versatile disk (DVD), etc,), a smart card or a flash memory device (e.g., an erasable programmable read-only memory (EPROM), a card, a stick or a key drive, etc.). The various computer-readable storage media described in the present disclosure may represent one or more devices and/or other machine-readable storage media for storing information. The term “machine-readable storage media” may include, but is not limited to, wireless channels and various other media capable of storing, containing and/or carrying instructions and/or data.

Some embodiments of the present disclosure provide a computer program product. The computer program product includes computer program instructions that, when executed on a computer, cause the computer to perform one or more steps of the method for obtaining the luminance correction relationship in the above embodiments, or to perform one or more steps of the correction method as described in the above embodiments.

Some embodiments of the present disclosure further provide a computer program. When the computer program is executed on the computer, the computer program causes the computer to perform one or more steps of the method for obtaining the luminance correction relationship in the above embodiments, or to perform one or more steps of the correction method as described in the above embodiments.

The computer-readable storage medium, the computer program product and the computer program have the same beneficial effects as the method for obtaining luminance correction relationships of three primary colors or the correction method in some of the above embodiments, which will be not repeated herein again.

The forgoing descriptions are merely specific implementations of the present disclosure, but the protection scope of the present disclosure is not limited thereto. Any person skilled in the art could conceive of changes or replacements within the technical scope of the present disclosure, which shall all be included in the protection scope of the present disclosure. Therefore, the protection scope of the present disclosure shall be subject to the protection scope of the claims.

1. A method for obtaining luminance correction relationships of three primary colors, comprising:
setting target white color coordinates, a target white luminance and a gamma value;
calculating a first luminance value of each primary color at each gray scale according to the target white color coordinates, the target white luminance and the gamma value;
measuring color coordinates of the primary color at each gray scale, and
generating a list of a correspondence among the gray scale, the first luminance value and the color coordinates of the primary color;
selecting a plurality of gray scales, and
obtaining color coordinates corresponding to each of the plurality of gray scales according to the list;
calculating a second luminance value of the primary color at each of the plurality of gray scales according to the target white color coordinates, the color coordinates and the target white luminance; and
obtaining and storing a luminance correction relationship of the primary color according to the second luminance value of the primary color at each of the plurality of gray scales and a first luminance values corresponding to each of the plurality of gray scales.

2. The method according to claim 1, wherein calculating the first luminance value of the primary color at each gray scale according to the target white color coordinates, the target white luminance and the gamma value includes:
obtaining stable color coordinates of the primary color when a display displays a picture of the primary color;
calculating an initial luminance of the primary color according to the stable color coordinates of the primary color, the target white color coordinates and the target white luminance; and
calculating the first luminance value of the primary color at each gray scale according to the initial luminance of the primary color and the gamma value.

3. The method according to claim 2, wherein calculating the initial luminance of the primary color according to the stable color coordinates of the primary color, the target white color coordinates and the target white luminance includes:
calculating an initial luminance ratio of the primary color according to the stable color coordinates of the primary color and the target white color coordinates; and
calculating the initial luminance of the primary color according to the initial luminance ratio of the primary color and the target white luminance.

4. The method according to claim 2, wherein calculating the first luminance value of the primary color at each gray scale according to the initial luminance of the primary color and the gamma value includes:
obtaining a number of gray scales of the display;
using the initial luminance of the primary color as a luminance value of the primary color at a maximum gray scale; and
calculating a luminance value of the primary color at each gray scale according to a relational expression
$${L}_{X} = {( \frac{X}{MAX} )}^{GAM} \times L$$
among the gray scale, the luminance value and the gamma value as the first luminance value, wherein
GAM is the gamma value, MAX is the maximum gray scale, X is an X-th gray scale, L is the luminance value corresponding to the maximum gray scale, L_{X} is a luminance value corresponding to the X-th gray scale, and X is an integer.

5. The method according to claim 1, wherein calculating the second luminance value of the primary color at each of the plurality of gray scales according to the target white color coordinates, the color coordinates and the target white luminance includes:
calculating a first intermediate luminance ratio of the primary color at each of the plurality of gray scales according to the target white color coordinates and the color coordinates; and
calculating the second luminance value of the primary color at each of the plurality of gray scales according to the first intermediate luminance ratio and the target white luminance.

6. The method according to claim 1, wherein calculating the second luminance value of the primary color at each of the plurality of gray scales according to the target white color coordinates, the color coordinates and the target white luminance includes:
calculating a first intermediate luminance ratio of the primary color at each of the plurality of gray scales according to the target white color coordinates and the color coordinates;
calculating a first intermediate luminance value of the primary color at each of the plurality of gray scales according to the first intermediate luminance ratio and the target white luminance; and
cycling following steps at least once:
obtaining the color coordinates of the primary color at each of the plurality of gray scales from the list according to the first intermediate luminance value of the primary color at each of the plurality of gray scales, and
calculating a second intermediate luminance ratio of the primary color at each of the plurality of gray scales according to the target white color coordinates and the color coordinates;
calculating a second intermediate luminance value of the primary color at each of the plurality of gray scales according to the second intermediate luminance ratio of the primary color at each of the plurality of gray scales and the target white luminance;
using a second intermediate luminance value obtained in each cycle as a first intermediate luminance value of a next cycle except for a last cycle; and
using a second intermediate luminance value obtained after completion of the last cycle as the second luminance value.

7. The method according to claim 1, wherein obtaining the luminance correction relationship of the primary color according to the second luminance value of the primary color at each of the plurality of gray scales and the first luminance values corresponding to each of the plurality of gray scales includes:
obtaining a ratio of the second luminance value of the primary color at each of the plurality of gray scales to the first luminance values corresponding to each of the plurality of gray scales according to the second luminance value of the primary color at each of the plurality of gray scales and the first luminance values corresponding to each of the plurality of gray scales; and
obtaining and storing the luminance correction relationship of the primary color according to the ratios.

8. The method according to claim 7, wherein obtaining and storing the luminance correction relationship of the primary color according to the ratio includes:
performing a linear interpolation processing or fitting processing on the ratio to obtain and store the luminance correction relationship of the primary color.

9. The method according to claim 1, wherein the three primary colors are red, green and blue colors.

10. A correction method of a display, comprising:
measuring a luminance of each of three primary colors of the display at each gray scale;
calculating a target luminance of the primary color at each gray scale according to the luminance correction relationship of the primary color obtained by the method of claim 1, and a luminance of the primary color measured at each gray scale;
obtaining a target driving voltage corresponding to the target luminance of the primary color at each gray scale; and
adjusting a driving voltage of the display at each gray scale to the target driving voltage, so that the luminance of the primary color at each gray scale is the target luminance.

11. A correction apparatus of a display, comprising
a measuring device configured to measure a luminance of each of three primary colors of the display at each gray scale;
a calculating device coupled to the measuring device, the calculating device being configured to calculate a target luminance of the primary color at each gray scale according to the luminance correction relationship of the primary color obtained by the method of claim 1 and the measured luminance of the primary color at each gray scale;
an obtaining device coupled to the calculating device, the obtaining device being configured to obtain a target driving voltage corresponding to the target luminance of the primary color at each gray scale; and
an adjusting device coupled to the obtaining device, the adjusting device being configured to adjust a driving voltage of the display at each gray scale to the target driving voltage, so that the luminance of the primary color at each gray scale is the target luminance.

12. A display device, comprising:
the correction apparatus according to claim 11; and
a display coupled to the correction apparatus.

13. A non-transitory computer-readable storage medium storing computer programs that, when executed on a processor, cause one or more steps of the method according to claim 1 to be performed.

14. An electronic apparatus, comprising:
a storage device storing one or more computer programs that are able to be executed on a processing device; and
the processing device, when the computer programs are executed on the processing device, to perform one or more steps of the obtaining method according to claim 1.

15. A non-transitory computer-readable storage medium, storing computer programs that, when executed on a processor, cause one or more steps of the correction method according to claim 10 to be performed.

16. An electronic apparatus, comprising:
a storage device storing one or more computer programs that are able to be executed on a processing device; and
the processing device, when the computer programs are executed on the processing device, to perform one or more steps of the correction method according to claim 10.
